(19) United States
(12) Patent Application Publication
(10) Pub. No.: US 2026/0100889 A1
(43) Pub. Date: Apr. 9, 2026

(54) APPARATUSES AND METHODS FOR INTRODUCING A DATA CONTEXT WITH AN MACHINE LEARING MODEL

(71) Applicant: Lenovo (Singapore) Pte. Ltd., Singapore (SG)

(72) Inventors: Konstantinos Samdanis, Munich (DE); Dimitrios Karampatsis, Ruislip (GB)

(21) Appl. No.: 19/113,887

(22) PCT Filed: Jan. 4, 2023
(86) PCT No.: PCT/EP2023/050124

§ 371 Date: Mar. 20, 2025

(30) Foreign Application Priority Data
Nov. 9, 2022 (GR) 20220100922

(51) Int. Cl. H04L 41/16; H04L 41/40; H04W 24/08

(52) U.S. Cl. CPC H04L 41/16; H04L 41/40; H04W 24/08

(57) ABSTRACT

There is provided an apparatus comprising and a processor coupled with a memory. The processor is configured to cause the apparatus to receive a request message for an analytics service that uses a machine learning (ML) model, the request comprising a use case parameter; determine the ML model based on the use case parameter and a current network state, wherein the ML model is for deriving analytics information for a wireless communication network; and transmit a response message comprising analytics service information based on the determined ML model.

### FIELD

The subject matter disclosed herein relates generally to the introduction of a data context, in particular indicated by a network state parameter, with a Machine learning model.

### BACKGROUND

Network analytics and Artificial Intelligence (AI)/Machine learning (ML) is deployed in the 5G core network via the introduction of a Network Data Analytics Function (NWDAF). Various analytics types, that can be distinguished using different Analytics IDs, e.g., “UE Mobility”, “NF Load”, etc., may be supported. This is discussed in TS 23.288.

Each NWDAF may support one or more Analytics IDs and may have the role of implementing: (i) AI/ML inference, called NWDAF AnLF, or (ii) AI/ML training, called NWDAF MTLF, or (iii) both.

TS 23.288 introduces the Analytics Data Repository Function (ADRF) that supports storage and retrieval of analytics generated by NWDAFs and other collected data.

U.S. Pat. No. 10,572,321B2 discloses techniques for providing and servicing listed repository items such as algorithms, data, models, pipelines, and/or notebooks. In some examples, web services provider receives a request for a listed repository item from a requester, the request indicating at least a category of the repository item and each listing of a repository item includes an indication of a category that the listed repository item belongs to and a storage location of the listed repository item, determines a suggestion of at least one listed repository item based on the request, and provides the suggestion of the at least one listed repository item to the requester.

### SUMMARY

Disclosed herein are apparatuses and procedures for introducing a data context with an ML Model, for example, for storage in an ADRF.

There is provided an apparatus comprising a transceiver and a processor coupled to the transceiver. The processor and the transceiver configured to cause the apparatus to: include, in a message identifying a machine learning model, a network state parameter, wherein: the machine learning model is for deriving analytics information for a wireless communication network; the machine learning model has been trained using training data acquired from the wireless communication network when the wireless communication network was in a particular network state; and the network state parameter is indicative of the particular network state.

There is further provided method comprising including, by a processor, a network state parameter in a message identifying a machine learning model. The machine learning model is for deriving analytics information for a wireless communication network. The machine learning model has been trained using training data acquired from the wireless communication network when the wireless communication network was in a particular network state. The network state parameter is indicative of the particular network state.

There is further provided an apparatus comprising a memory and a processor coupled to the memory. The processor and the memory configured to cause the apparatus to: store, in the memory, a machine learning model, the machine learning model being for deriving analytics information for a wireless communication network, the machine learning model having been trained using training data acquired from the wireless communication network when the wireless communication network was in a particular network state; and store, in the memory, a network state parameter associated with the machine learning model, the network state parameter being indicative of the particular network state.

There is further provided a method comprising: storing, in a memory, a machine learning model, the machine learning model being for deriving analytics information for a wireless communication network, the machine learning model having been trained using training data acquired from the wireless communication network when the wireless communication network was in a particular network state; and storing, in the memory, a network state parameter associated with the machine learning model, the network state parameter being indicative of the particular network state.

There is further provided an analytics consumer comprising a transceiver and a processor coupled to the transceiver. The processor and the transceiver configured to cause the apparatus to include, in a message, a network state parameter, and send, to another apparatus, the message. The message is a request to be provided with analytics information or a subscription thereto. The network state parameter is indicative of a particular network state. The network state parameter is useable for the selection of a machine learning model.

There is further provided a method for performance by an analytics consumer. The method comprises including, in a message, a network state parameter, and sending, to another apparatus, the message. The message is a request to be provided with analytics information or a subscription thereto. The network state parameter is indicative of a particular network state. The network state parameter is useable for the selection of a machine learning model.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for introducing a data context with an ML Model, for example, for storage in an ADRF will now be described, by way of example only, with reference to the accompanying drawings, in which:

FIG. 1 depicts a wireless communication system;

FIG. 2 depicts a user equipment apparatus;

FIG. 3 depicts a network node;

FIG. 4 is a schematic illustration of a network, and illustrates various types of NWDAF;

FIG. 5 is a schematic illustration depicting a data storage architecture for Analytics and Collected Data;

FIG. 6 depicts an example ML model ID composition or structure;

FIG. 7 is a process flow chart showing a process of requesting and receiving network data analytics;

FIG. 8 is a process flow chart showing a process of subscribing/unsubscribing to be notified of network data analytics;

FIG. 9 is a process flow chart showing a process of requesting and receiving ML model Information

FIG. 10 is a process flow chart showing a process of subscribing/unsubscribing to be notified of ML Model Information;

FIG. 11 is a process flow chart showing various processes;

FIG. 12 is a process flow chart of a method for introducing a data context (in particular indicated by a network state parameter) with a Machine learning model;

FIG. 13 is a process flow chart of a method for storing a data context (in particular indicated by a network state parameter) with a Machine learning model; and

FIG. 14 is a process flow chart of a method of a consumer requesting Analytics Information for a particular Analytics ID, indicating a specific data context.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of”′ includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

This disclosure relates to an apparatus and method that introduces a network state or network context that describes the training conditions of an ML model, and the capability to request, store, search and retrieve an ML model when a consumer's needs match a desired network state.

An ML model in machine learning is created by an ML algorithm. In other words, an ML algorithm specifies a procedure, e.g., pattern recognition, that runs considering data (i.e., training data) to create an ML model. These processes in machine learning can be commonly defined as follows:
ML model: An ML model can be a mathematical representation of a real-world process. To generate an ML model, one may provide training data to an ML algorithm to learn from. An ML model can then be used for ML inference or simply inference.
ML inference: Is a process where an ML model is fed with observation data, (i.e., data from where the ML model operates), and calculates an output result. This process is commonly referred to as “operationalizing a machine learning model” or “putting a machine learning model into production”.
ML algorithm: An ML algorithm is the hypothesis set that is taken at the beginning before the training starts with real-world data. For instance, a hypothesis set considering a Linear Regression algorithm means a set of functions that share the characteristics defined by Linear Regression. From those set of functions, an ML model is the selected function that fits best the training data.
ML training: Is a process where an ML algorithm is fed with training data to find patterns such that the input parameters correspond to the target. The output of the training process is an ML model, which can be used to provide analytics results. This process is also referred to as “learning”.

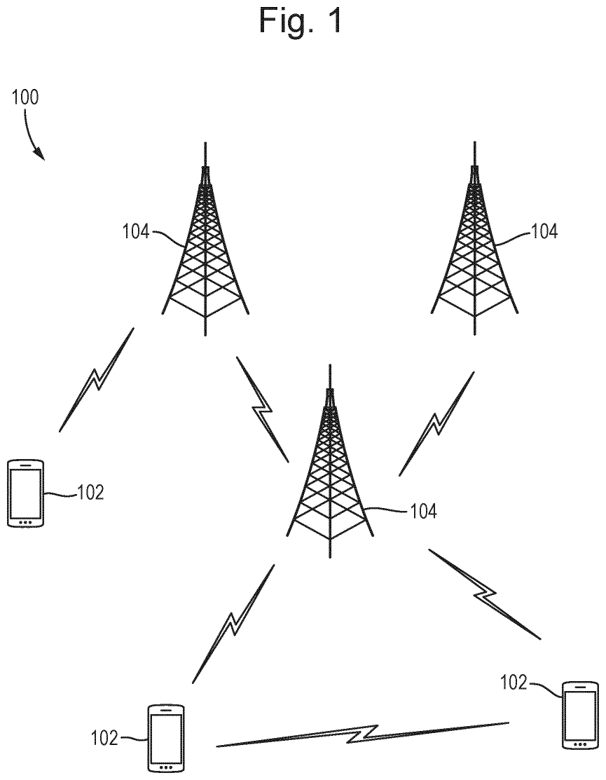

FIG. 1 depicts an embodiment of a wireless communication system 100 in which apparatuses and method for introducing data context (i.e., a network state or network context) that describes the training conditions of an ML model may be implemented. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

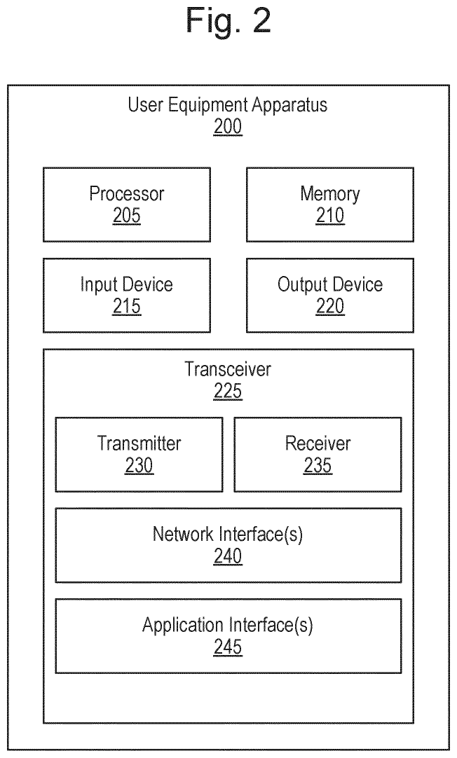

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may be the same as or in accordance with a remote unit 102 described above with reference to FIG. 1. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller.

The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display.

The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module.

Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

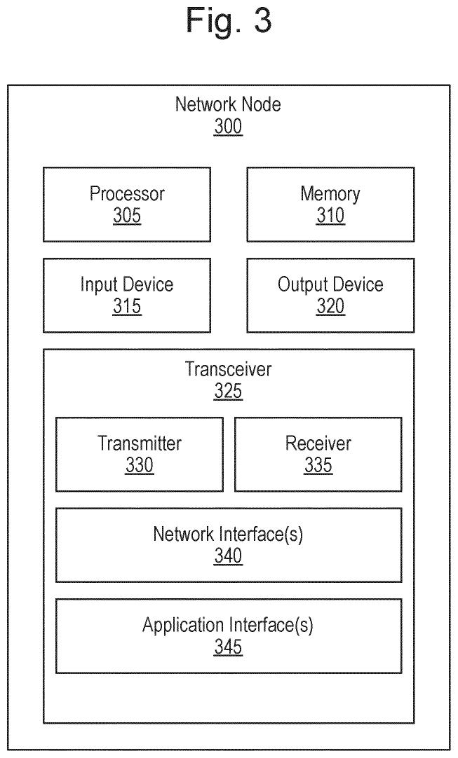

FIG. 3 depicts further details of the network node 300 that may be used for implementing the methods described herein. The network node 300 may be one implementation of an entity in the wireless communications network, e.g. in one or more of the wireless communications networks described herein. The network node 300 may be, for example, the UE 200 described above, or a Network Function (NF) or Application Function (AF), or another entity, of one or more of the wireless communications networks of embodiments described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display.

The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

The following information is useful in the understanding of the methods and apparatuses for data preparation for analytics data in the 3GPP architecture, which are described later below.

Currently, network analytics and AI/ML is deployed in the 5G core network via the NWDAF. Various analytics types may be supported. The various analytics types can be distinguished using different Analytics IDs, e.g., “UE Mobility”, “NF Load”, etc. This is discussed in TS 23.288. Each NWDAF may support one or more Analytics IDs and may have the role of: (i) AI/ML inference, called NWDAF AnLF; or (ii) AI/ML training, called NWDAF MTLF; or (iii) both.

NWDAF AnLF, or simply AnLF, and NWDAF MTLF, or simply MTLF, represent logical functions that can be deployed as standalone functions or in combination. AnLF that supports a specific Analytics ID inference using an AI/ML Model subscribes to a corresponding MTLF that is responsible for the training of the same AI/ML Model used for the respective Analytics ID.

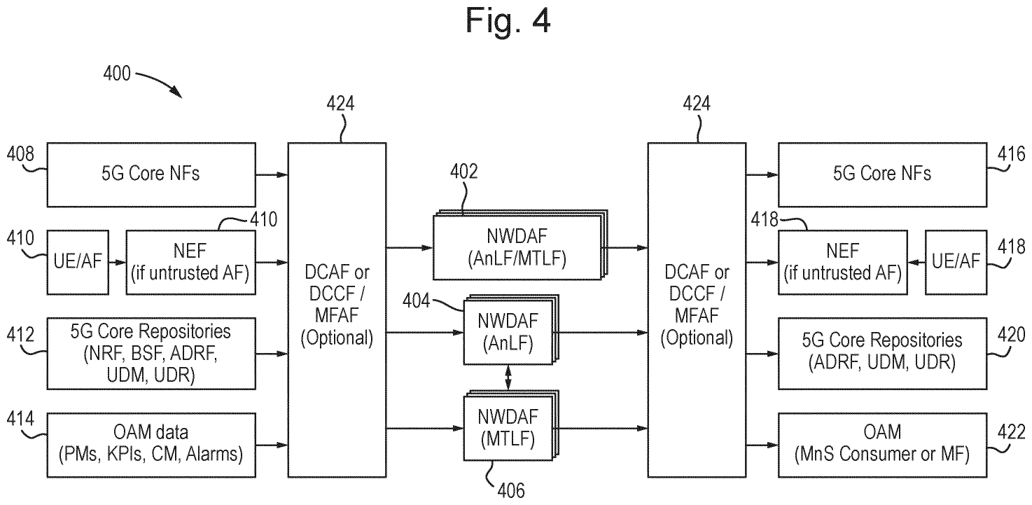

FIG. 4 is a schematic illustration of a network 400, and illustrates the various NWDAF “flavours” or types (specifically an NWDAF AnLF/MTLF 402, an NWDAF AnLF 404, and an NWDAF MTLF 406), and their respective input data and output result consumers. Specifically, an Analytics ID, contained in a NWDAF 402, 404, 406, relies on various sources of data input including data from 5G core NFs 408, AFs 410, 5G core repositories 412, e.g., Network Repository Function (NRF), UDM, etc., and OAM data 414, e.g., PMs/KPIs, CM data, alarms, etc. An Analytics ID contained in AnLF and may provide analytics output result towards 5G core NF 416, AF 418, 5G core repositories 420, e.g., UDM, UDR ADRF, or OAM MnS Consumer or MF 422.

MTLF and AnLF may exchange AI/ML models, e.g., via the means of serialization, containerization, etc., including related model information. Optionally, a DCCF and MFAF 424 may be involved to distribute and collect repeated data towards or from various data sources.

TS 23.288 introduces the ADRF that supports storage and retrieval of analytics generated by NWDAFs and other collected data.

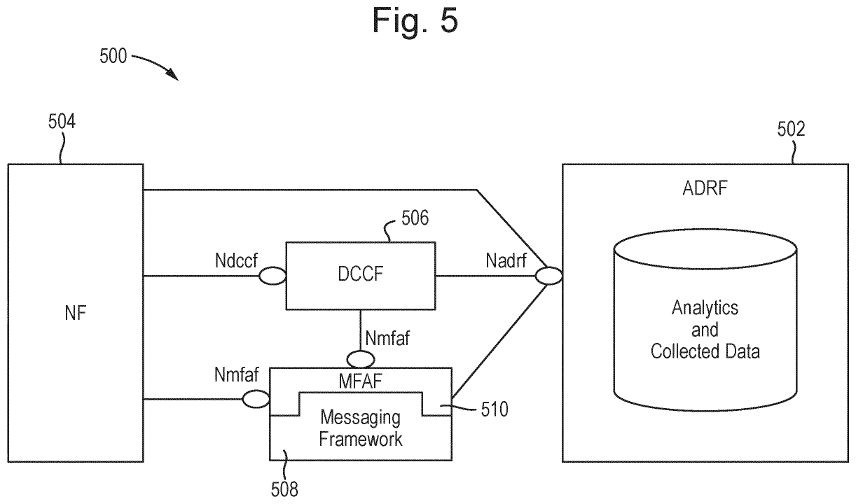

FIG. 5 is a schematic illustration depicting a data storage architecture for Analytics and Collected Data, as defined in TS 23.288. FIG. 5 depicts the ADRF architecture in 5G. The architecture 500 supports the following options:
the ADRF 502 provides storage and retrieval of data by other 5GC NFs 504 (e.g., NWDAF).
Based on the NF request or configuration on the DCCF 506, the DCCF 506 may determine the ADRF 502 and interact directly or indirectly with the ADRF 502 to request or store data. The interaction can be:
Direct, i.e. the DCCF 506 requests to store data in the ADRF 502, or via a notification (e.g., when ADRF 502 requested data collection notification via DCCF 506). In addition, the DCCF 506 retrieves data from the ADRF 502;
Indirect: the DCCF 506 requests the Messaging Framework 508 to store data in the ADRF 502. The Messaging Framework 508 may contain one or more Adaptors that translate between 3GPP defined protocols;
A Consumer NF 504 may specify in requests to a DCCF 506 that data provided by a Data Source needs to be stored in the ADRF 502.
The ADRF 502 stores data received directly from an NF 504, or data received in a notify message from the DCCF 506, MFAF 510 or from the NWDAF.
The ADRF 502 checks if the Data Consumer is authorized to access ADRF services and provides the requested data using the procedures specified in TS 23.501 clause 7.1.4.

In TR 23.700-81, the ADRF storage and retrieval services are enhanced to support ML models. In other words, the ADRF supports:
Trained ML model(s) file and ML model file serialization format stored by NF consumer i.e., NWDAF containing MTLF.
Trained ML model(s) file retrieval by NF consumer i.e., NWDAF containing AnLF.

The ADRF should be able to store historical ML model and send the historical ML model with wider range than the ML model filter information using new services for ML model storage, provisioning and update.

By storing an ML model in ADRF, a more efficient ML model sharing is enabled without overloading MTLFs that may handle multiple ML models and ML model consumers. An ML model consumer may then subscribe and request a ML model from the corresponding ADRF instead of the respective MTLF reducing in this way its workload.

The trained ML model profile stored by the NWDAF containing MTLF and retrieved by the NWDAF containing AnLF may include one of the following parameters:
an identification of the location related to the ML model, e.g., NWDAF ID, ADRF ID, etc.
an ML Model ID related to each historical ML model version stored.
an Analytics ID and/or model framework (i.e., analytics type that may also include, e.g. without explicitly mentioning, the corresponding standardized input data sources).
ML model implementation details, e.g., model platform, model type, algorithm, compilation language, etc.
an ML model serialization format that deals with interoperability, i.e., if the model retrieved can be used in the indicated platform or vendor.
ML model usage information which may include, but is not limited to, spatial validity, model validity period, model accuracy, model space effectiveness, model file, S-NSSAI, Area of Interest, target objects (e.g., UE(s), NF(s)), model target period, and other model content information such as that specified in clause 6.2A.2 of TS 23.288.
a notification end point that is expected to receive the ML model.

In some conventional applications, a consumer may place a query using an application programming interface (API) to find and select shared content to build a pipeline and/or cause execution or training of a selected model or algorithm using execution resources and storage. A query may include one or more of: a category and/or subcategory, data information (i.e., data format availability to the consumer), resource availability for use, e.g., processor type, timing information (e.g., desired latency), an indication of a pipeline that the model/algorithm/data is to be used for, desired accuracy, type of content (algorithm, model, and/or data), etc. The response to the query may include the relative usage, storage location of the data, and a few test cases (i.e., inputs and outputs) to be used in verification and testing process.

Current proposals mainly focus on the capability to store and retrieve an ML model considering a wide variety of filtering information. However, none of the proposals describe and store the conditions and the state of the network environment when an ML model was trained at MLTF. Although the Analytics ID that points to specific data sources that can be used in the training process may be included in the filtering information, the network topology and the usage of these data sources is not certain and may vary depending on the network state.

Some prior art proposals in 3GPP (e.g., Solution #62 in 3GPP TR 23.700-81 v1.1.0) discloses a method where an analytics consumer includes a use case context identifier. Such a use case context identifier may be used by the NWDAF to select a particular ML model according to the type of user, specific circumstances, or application requested. It is assumed that the NWDAF is pre-configured to select a particular ML model according to the use case requested. Such procedure does not allow the NWDAF to determine the network conditions, i.e., network state (such as energy saving, faults, etc.) when such analytics are requested, nor does it allow the NWDAF to select an ML model based on the network conditions, e.g. data sources consumed, when the ML model was trained.

This aspect is significant since the same ML model may be trained at the same geographical area (i.e., same spatial validity) at different times, with the network state being different, e.g., due to a fault at certain base stations. Energy saving or special events, e.g., a sports game, may also cause variations in the network state. ML models trained under different network states, e.g. using a different network topology and/or load distribution, may produce distinct trained ML models. Hence, capturing only the ML model implementation, interoperability and usage is not enough.

The present disclosure introduces the notion of network state in relation with a trained ML model, and introduces a method to store, search, and/or retrieve it when a consumer requests an ML model for the purpose of inference or further training.

This present disclosure may assume that more than one ML model is available to choose for a specific Analytics ID. Each ML model may carry or be associated with a unique identifier, i.e., an ML model ID, as proposed in clause 6.61.2 of TR 23.700-81.

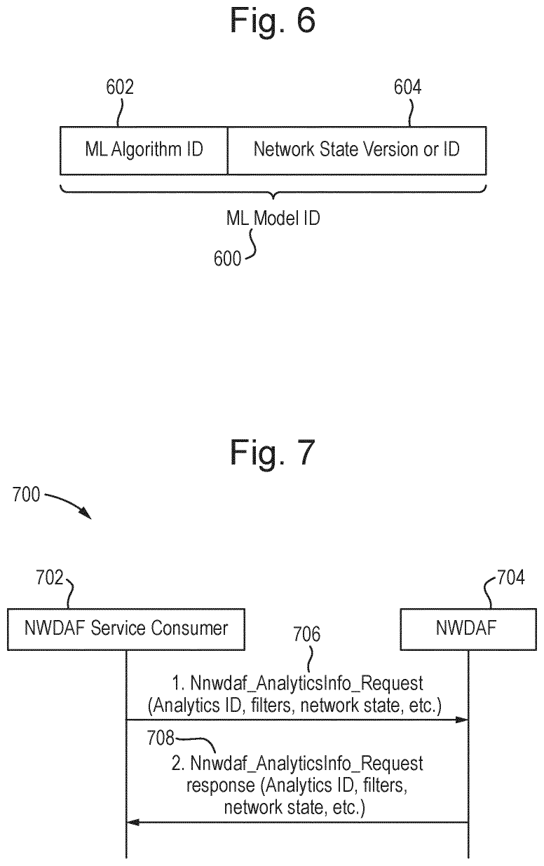

The ML model ID may also be associated with the corresponding ML algorithm, e.g., in a hierarchical naming relation. An ML model may be trained considering the same geographical area and data sources under different network states, thereby producing distinct trained ML models which can be used for inference. Hence, distinct ML models IDs preferably additionally consider and reflect different versions with respect to the corresponding network state, which was used for the purpose of training. The relation of the ML algorithm, network state version or ID and ML model ID may be as illustrated in FIG. 6.

FIG. 6 depicts an example ML model ID 600 which may be implemented in embodiments of the present invention. The ML model ID 600 comprises an ML algorithm ID 602 and network state version or ID 604.

For example, a unique ML model ID may be introduced per different ML algorithm, e.g., for each of peak traffic and off-peak traffic conditions if these conditions influence the ML model training and result in a different trained ML model. The same can hold for different network congestion conditions, network faults, and network configurations, or simply when different portions and type of data sources are used to train an ML model.

From the consumer perspective, the selection of a ML model preferably accommodates the production of analytics reflecting the encountered network conditions, circumstances, and usage, e.g., for a specific UE or application, or a network configuration, fault, or malfunction. Conventionally, NWDAF AnLF allows a consumer to select the accuracy level, time scheduling, area of interest, and target objects, but these attributes cannot determine the network conditions semantics. In other words, the current attributes are not sufficient to allow the analytics consumer to select the relevant ML model (i.e., the ML model trained under the required network conditions) assuming that NWDAF AnLF can accommodate multiple ML models.

In addition, the current ML model info attributes listed in clause 6.2A.2 of TS 23.288 tend not to be sufficient to allow the NWDAF to select the relevant ML model for interference or further training. An explicit indication of the network conditions, circumstances, and usage by the analytics consumer and/or ML model consumer can help the NWDAF (both AnLF and MTLF) choose the most relevant ML model.

The network conditions, circumstances, and usage can be reflected by the network state, which can take the form of an identifier or version, e.g., string or scalar, out of a pre-configured list (known to analytics consumers e.g., AF, NFs, and OAM) and valid in the entire PLMN. An analytics consumer, e.g., AF, NF, or OAM, may indicate the network state identifier or version to the NWDAF AnLF. Optionally, the analytics consumer may indicate the desired ML algorithm ID, if the AnLF supports multiple ML models trained by different algorithms for the same Analytics IDs, and the analytics consumer is aware of this (i.e., has knowledge of the specific algorithm ID). The network state identifier or version reflects can be a combination of:
a network condition or network configuration related to a network object, e.g., NF, or area of interest;
a user policy related to a UE or session/flow (optionally if the target of analytics reporting, as specified in clause 6.1.3 TS 23.288, indicates a specific UE or a group of UEs).

When the AnLF and MTLF are contained in different NWDAF instances, the AnLF may use the network state identifier or version to select the desired ML Model ID out of the ones available. Optionally, the AnLF may need to indicate the desired ML algorithm ID, if the MTLF supports multiple ML models trained by different algorithms for the same Analytics ID.

The present disclosure introduces enhancements on existing procedures by introducing a new parameter related to the network state version or identifier (and optionally the ML algorithm ID). This may be included in, for example, the:
i) Nnwdaf_AnalyticsInfo service,
ii) Nnwdaf_AnalyticsSubscription service,
iii) Nnwdaf_MLModelInfo service, and/or
iv) Nnwdaf_MLModelProvision service.

In some embodiments, the analytics consumer, e.g. the NWDAF Service Consumer (e.g., NFs/OAM), may add the parameter on the network state version or identifier (and optionally the algorithm ID) to a request, and get, from the NWDAF, analytics information using Nnwdaf_AnalyticsInfo service. This is illustrated in FIG. 7.

FIG. 7 is a process flow chart showing an embodiment of a process 700 of requesting and receiving network data analytics.

The process 700 involves an NWDAF service consumer 702 and an NWDAF 704.

The NWDAF service consumer 702 and/or the NWDAF 704 may be the same as or in accordance with any network entity, function, or node described herein. For example, the NWDAF service consumer 702 and an NWDAF 704 may be the same as the network node 300 shown in FIG. 3 and described in more detail earlier above.

At step 706, the NWDAF service consumer 702 (e.g., NFs/OAM) requests analytics information by invoking an Nnwdaf_Analytics Info_Request service operation. Parameters that can be provided by the NWDAF service consumer 702 are listed in clause 6.1.3 of TS 23.288 and include, but are not limited to, Analytics ID, filter information, target object, time scheduling, etc. A network state parameter (e.g. a networks state version or identifier), and optionally the ML algorithm ID, are included as additional parameter(s). The NWDAF service consumer 702 sends the Nnwdaf_Analytics Info_Request message containing the network state parameter to the NWDAF 704.

At step 708, the NWDAF 704 responds with analytics information to the NWDAF service consumer 702.

In some embodiments, the analytics consumer, i.e., NWDAF Service Consumer, (e.g., NFs/OAM), can subscribe/unsubscribe at the NWDAF, indicating the network state parameter (e.g. the network state version or identifier) and optionally the ML algorithm ID, to be notified on analytics information, using Nnwdaf_AnalyticsSubscription service. The Nnwdaf_AnalyticsSubscription service may also be used to modify an existing analytics subscription(s).

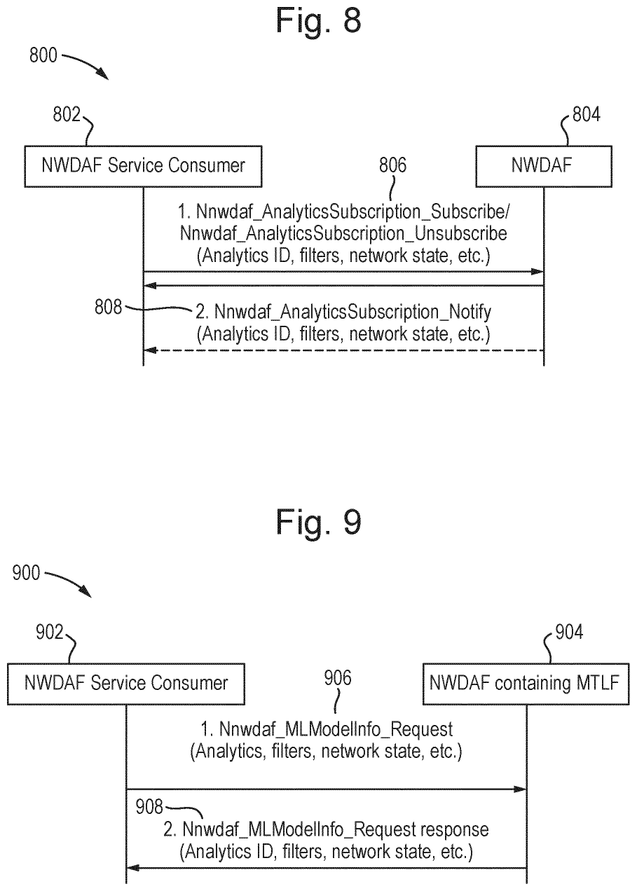

FIG. 8 is a process flow chart showing an embodiment of a process 800 of subscribing/unsubscribing to be notified of network data analytics.

The process 800 involves an NWDAF service consumer 802 and an NWDAF 804.

The NWDAF service consumer 802 and an NWDAF 804 may be the same as or in accordance with any network entity, function, or node described herein. For example, the NWDAF service consumer 802 and/or the NWDAF 804 may be the same as the network node 300 shown in FIG. 3 and described in more detail earlier above.

At step 806, the NWDAF service consumer 802 (e.g., NFs/OAM) subscribes to or cancels subscription to analytics information by invoking the /wdaf_AnalyticsSubscription_Subscribe/ Nnwdaf_AnalyticsSubscription_Unsubscribe service operation. Parameters that can be provided by the NWDAF service consumer are listed in clause 6.1.3 TS 23.288. The network state parameter (e.g. a network state version or identifier), and optionally the algorithm ID, are included as additional parameter(s).

At step 808, if the NWDAF service consumer 802 is subscribed to analytics information, the NWDAF 804 notifies the NWDAF service consumer 802 with the analytics information by invoking Nnwdaf_AnalyticsSubscription_Notify service operation, based on the request from the NWDAF service consumer 802, e.g., Analytics Reporting Parameters including Network state version of identifier (and optionally the algorithm ID). If the NWDAF 804 provides a Termination Request, then the consumer 802 cancels its subscription to analytics information by invoking the Nnwdaf_AnalyticsSubscription_Unsubscribe service operation.

In some embodiments, the NWDAF AnLF, i.e., in this embodiment the NWDAF Service Consumer (as per clause 6.2A.3 TS 23.288), may add the network state parameter (e.g. the network state version or identifier), and optionally the algorithm ID, when it requests and gets, from an NWDAF MTLF, ML Model Information, using Nnwdaf_MLModelInfo services. This is shown in FIG. 9.

FIG. 9 is a process flow chart showing an embodiment of a process 900 of requesting and receiving ML model Information.

The process 900 involves an NWDAF service consumer 902, i.e., NWDAF AnLF, and an NWDAF MTLF 904.

The NWDAF service consumer 902, i.e., NWDAF AnLF, and an NWDAF MTLF 904 may be the same as or in accordance with any network entity, function, or node described herein. For example, the NWDAF service consumer 902, i.e., NWDAF AnLF, and/or the NWDAF MTLF 904 may be the same as the network node 300 shown in FIG. 3 and described in more detail earlier above.

At step 906, the NWDAF service consumer 902, i.e., NWDAF AnLF, requests a (set of) ML Model(s) associated with a (set of) Analytics ID(s) by invoking Nnwdaf_MLModelInfo_Request service operation. Parameters that can be provided by the NWDAF Service Consumer 902 are listed in clause 6.2A.2 of TS 23.288, and may include the network state parameter (e.g. a network state version or identifier), and optionally the ML algorithm ID.

When a request to an ML Model Information for the Analytics is received, the NWDAF MTLF 904 may:
determine whether an existing trained ML Model can be used for the request; or
determine whether triggering further training for an existing trained ML models is needed for the request.

If the NWDAF containing MTLF 904 determines that further training is needed, this NWDAF 904 may initiate data collection to generate the ML model.

At step 908, the NWDAF MTLF 904 responds with the ML Model Information (containing a (set of) file address of the trained ML model) to the NWDAF service consumer 902 by invoking Nnwdaf_MLModelInfo_Request response service operation. The content of ML Model Information that can be provided by the NWDAF containing MTLF 904 may be as specified in clause 6.2A.2 TS 23.288, and further includes the network state parameter (e.g. the network state version or identifier) and optionally the ML algorithm ID.

In some embodiments, the NWDAF AnLF, i.e., NWDAF Service Consumer (as per clause 6.2A.1 of TS 23.288), adds the network state parameter (e.g. the network state version or identifier) and optionally the ML algorithm ID when subscribing/unsubscribing an NWDAF containing MTLF to be notified when ML Model Information on the related Analytics becomes available, using Nnwdaf_MLModelProvision services.

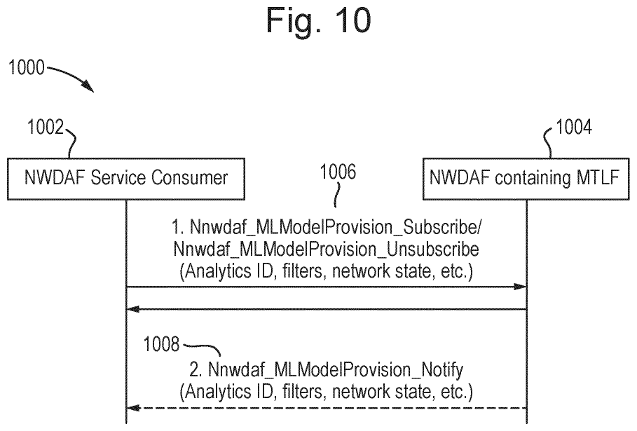

FIG. 10 is a process flow chart showing an embodiment of a process 1000 of subscribing/unsubscribing to be notified of ML Model Information.

The process 1000 involves an NWDAF service consumer 1002, i.e., NWDAF AnLF, and an NWDAF MTLF 1004.

The NWDAF service consumer 1002, i.e., NWDAF AnLF, and an NWDAF MTLF 1004 may be the same as or in accordance with any network entity, function, or node described herein. For example, the NWDAF service consumer 1002, i.e., NWDAF AnLF, and/or the NWDAF MTLF 1004 may be the same as the network node 300 shown in FIG. 3 and described in more detail earlier above.

At step 1006, the NWDAF service consumer 1002 (i.e., NWDAF AnLF) subscribes to, modifies, or cancels subscription for a (set of) trained ML Model(s) associated with a (set of) Analytics ID(s) by invoking the Nnwdaf_MLModelProvision_Subscribe/Nnwdaf_MLModelProvision_Unsubscribe service operation. Parameters that can be provided by the NWDAF service consumer listed in clause 6.2A.2 TS 23.288 and further include the network state parameter (e.g. the network state version or identifier) and optionally the ML algorithm ID.

When a subscription for a trained ML model associated with an Analytics ID is received, the NWDAF containing MTLF 1004 may:
determine whether an existing trained ML Model can be used for the subscription; or
determine whether triggering further training for an existing trained ML models is needed for the subscription.

If the NWDAF containing MTLF 1004 determines that further training is needed, this NWDAF 1004 may initiate data collection to generate the ML model.

At 1008, NWDAF MTLF 1004 notifies the NWDAF service consumer 1002, i.e., NWDAF AnLF, with the trained ML Model Information (containing a (set of) file address of the trained ML model) by invoking Nnwdaf_MLModelProvision_Notify service operation. The content of trained ML Model Information that can be provided by the NWDAF containing MTLF 1004 may be as specified in clause 6.2A.2 of TS 23.288, and further includes the network state parameter (e.g. the network state version or identifier) and optionally the ML algorithm ID.

The NWDAF MTLF 1004 invokes the Nnwdaf_MLModelProvision_Notify service operation to notify of an available re-trained ML model, for example when the NWDAF MTLF 1004 determines that the previously provided trained ML Model required re-training (that can be determined when the network state changes) at step 1006.

When step 1006 is performed for a subscription modification, or a network state alternation, (e.g., including Subscription Correlation ID), the NWDAF MTLF 1004 may provide either a new trained ML model, or re-trained ML model.

In some embodiments, the network state parameter may identify, for example, one or more of the following network attributes (i.e. the network state related to the network version or identifier can be described by, for example, one or more of the followed attributes):
Type of network, which may include the network technology and the purpose of usage, for example:
   Private network (e.g., 5G factory) or public network in a rural or urban environment;
   Radio Access Technology (RAT) in use, e.g., 5G, 4G, satellite, etc.
Network faults, errors, and/or malfunctions within or associated with the network. The network state parameter may identify objects involved and the associated faults, errors, or malfunction including security incidents. The network state parameter may identify:
   Network objects,
   Type of fault, error, or malfunction,
   Time duration of fault, error, or malfunction,
   Backup network object or function in use.
An energy saving state of the network. The network state parameter may identify objects involved and the associated energy mode. The network state parameter may identify:
   Network objects in energy saving state,
   Time duration of network objects in energy saving state,
   Energy saving state, i.e., energy modes related to specific network equipment, e.g., powered-off, or discontinued transmission, etc.
A network maintenance state of the network. The network state parameter may identify network objects out of operation involved in upgrades. The network state parameter may identify:
   Network objects out of operation,
   Network objects with different maintenance characteristics, e.g., software versions,
   Time duration where network objects are out of operation.
A network congestion level, which may include an average, standard deviation, or distribution of congestion. The network congestion level may be represented as a:
   Quantized value, e.g., high, medium, low,
   Percentage of the average network load over the network capacity.
Network configuration. This may represent the network conditions in terms of, for example:
   Connectivity settings, e.g., identity of network slice, RATs, reflectors/relays, etc.,
   Slice type, e.g., eMBB, mIoT, URLLC, V2X, etc.,
   DNN that stores certain offered services,
   Service quality, e.g., in terms of SLA, which may include throughput, latency, etc.,
   Policies and controls, e.g., data offloading, route optimization, use CoMP, etc.,
   Network ownership or network object ownership, e.g., edge cloud platform.
Data sources used for the purpose of the ML model training. This may include identifying:
   An identity of a data source from which data was obtained,
   A state or condition of the data source object, e.g., in energy saving state (powered-off), fault, load conditions, congestion level, etc.
   Time duration during which data was obtained.
Data statistics, which may specify or consider the distribution and correlation (i.e., dependencies) of data in terms of:
   Data range, e.g., minimum, and maximum values,
   Time intervals among consecutive data obtained,
   Time duration during which data was obtained,
   Data volume or amount of the data obtained,
   Frequency of data occurrence or repeated data occurrence, e.g., data value or state.
Historical data, which may be in the DCCF/MFAF or the ADRF. The historical data may be as specified in clause 5A.4 and clause 5A.5 of TS 23.288.
Trace data that may be represented as a “pointer” or indicator to identify network trace data, e.g., PM, MDT data or KPIs, in a respective trace database related to the network state. Such a “pointer” or indicator to the trace data can be described for example by one or a combination of:
   Time instance, i.e., initial or starting time instance, related to the desired PM, MDT data or KPI,
   Time duration related to the desired PM, MDT data or KPI,
   Geographical area or network object related to the desired PM, MDT data or KPI,
   Trace measurements, e.g., PM, MDT data or KPI, with each consumer potentially requesting a different set of traces, to serve their needs.

It shall be noted that the above-listed attributes are not necessarily determined by the NWDAF MTLF. Data-related attributes, i.e. data source(s), data statistics and historical data, may be determined by the NWDAF MTLF. Other attributes may be obtained by based on an interaction with the OAM and/or other 5G NF, e.g., PCF, and may for example consider the usage, i.e. the Analytics ID, in relation to the type of user, specific circumstances, i.e. network conditions, or application.

For instance, Analytics IDs related to an area of interest and/or an NF may require network state information from the OAM related to, e.g., energy saving, faults, etc. Other Analytics IDs related to specific UEs, sessions, QoE or applications may require additional information related to the policy and control from the PFC.

The service processes used related to the ML Model storage, registration, search, and/or provision may include, but are not limited to, the following:
ML Model storage towards the ADRF that may include the network state version and identifier including optionally the algorithm ID.
ML Model registration in the DCCF/MFAF or NRF that may include the network state version and identifier, and may optionally include the ML algorithm ID.
ML Model search in the NRF that may include the network state version and identifier including optionally the ML algorithm ID.

ML Model provision towards the ML Model consumer that can be the NWDAF AnLF or NWDAF MTLF that may include the network state version and identifier, and ma optionally include the ML algorithm ID.

For some embodiments:
the network state can be obtained by the NWDAF MTLF, for example by one or more of the following:
   considering the data sources used during the training process. A data source can supply “fresh” or new data directly. Instead of or in addition to the new data, historical data can be supplied e.g. via the DCCF/MFAF, ADRF or other data trace tools.
   considering to additionally include with the data sources the type of network related to the respective data source.
   considering to additionally include the state of the data sources, i.e., the conditions of the network object of the respective data source.
   considering additionally to include data statistics that can be calculated by the MTLF or obtained by another data entity.
the NWDAF MTLF can obtain the network state by interacting with the OAM. The NWDAF MTLF may perform one or more of the following:
   get informed why certain listed data sources are not available or not operating as expected. A “reasoning” label may be introduced which may indicate or identify, for example, a fault, malfunction, security issue, maintenance, energy saving state, etc.
   get a state related to a data source, e.g., <name, availability, start_time, time_duration>.
   get a pointer towards the respective trace data, (e.g., data entry number in the trace database), which may enable an ML model consumer to interact with the trace databased or any other similar tool that keeps network traces and be able to retrieve the network conditions when the ML model training was performed.
   get a network congestion level (e.g. an average level) related to area of interest, network entity or object, e.g., MnS, slice, etc.
the NWDAF MTLF can obtain the network state from a 5G NF, e.g., PCF. The NWDAF MTLF may perform one or more of the following:
   get SLA related to a particular service.
   get configuration policies, (e.g., route optimization, data offloading, connectivity, etc.) related to the provision of e.g., a service or slice in the form of e.g., <policy_name, network_object_list, start_time, time_duration>.
   get ownership information, e.g., <name, network object>; the name can be an identifier for a vertical, or vendor, or application provider, or a generic 3rd party.

Alternatively, the NWDAF may instruct the OAM and/or other 5G NFs to provide information about the network state to the ADRF directly by sharing the Model ID or another generic identification related to the ML model which needs a network state information update in the ADRF. This may be provided together with the time schedule, area of interest, network objects, etc. In some embodiments, a dedicated NF (which may be responsible for coordinating the network state with ML Model storage in the ADRF) or a logical NF in the DCCF/MFAF and/or the ADRF can assist in obtaining the network state considering the Model ID or another generic identification related to the ML model, together with the time schedule, area of interest, network objects, etc.

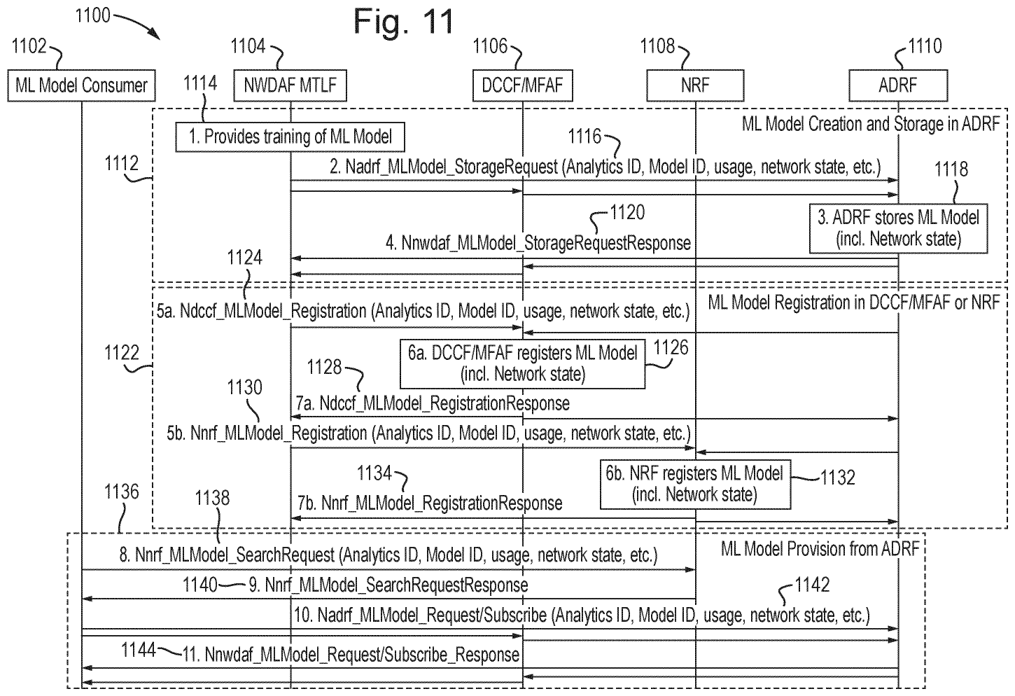

Embodiments described herein may enhance TR 23.700-81 Solution #43, ML model storage in ADRF and ML model provision from ADRF, by introducing the network state parameter, e.g. a network state version and identifier, and may optionally include the algorithm ID (e.g. as illustrated in FIG. 6, and/or as described with reference to FIG. 11 below) to complement the existing services.

FIG. 11 is a process flow chart showing processes 1100 of ML Model storage, registration and/or provision, and a process of subscribing/unsubscribing to be notified of ML Model Information, in accordance with embodiments of the invention.

The processes 1100 involve an ML model consumer 1102 (e, g, an NWDAF AnLF), an NWDAF MTLF 1104, a DCCF/MFAF 1106, an NRF 1108, and an ADRF 1110.

The ML model consumer 1102, the NWDAF MTLF 1104, the DCCF/MFAF 1106, the NRF 1108, and/or the ADRF 1110 may be the same as the network node 300 shown in FIG. 3 and described in more detail earlier above.

An ML model creation and storage process is depicted in FIG. 11 in a dashed box and indicated by the reference numeral 1112. The ML model creation and storage process 1112 comprises steps 1114 to 1120.

At step 1114, the NWDAF MTLF 1104 provides or determines training to the ML Model(s).

At step 1116, the NWDAF MTLF 1104 requests to store the ML Model to the ADRF 1110 by invoking Nadrf_MLModel_StorageRequest service operation. This service operation contains the trained ML model(s) and/or ML model(s) information, and the network state parameter (e.g. network state version and identifier), and optionally includes the ML algorithm ID). Alternatively, the NWDAF MTLF 1104 stores the trained ML Model to the ADRF 1110 via the DCCF 1106.

At step 1118, the ADRF 1110 stores the trained ML model(s) and/or the ML model(s) information including the network state parameter and optionally the ML algorithm ID. The ADRF 1110 may determine whether the same trained ML Model is already stored. If the trained ML Model is already stored, the ADRF 1110 may decide to update it including the associated network state parameter and, optionally, the ML algorithm ID. In some embodiments, if the new ML model is identical to the previous ML model, the ADRF 1110 may only updates the related network state information.

At step 1120, the ADRF 1110 sends a response to NWDAF MTLF 1104 indicating that the ML model is stored or updated using Nadrf_MLModel_StorageRequestResponse. This may be done either directly or via the DCCF 1106.

Thus, an ML model creation and storage process is provided.

ML model registration processes are depicted in FIG. 11 in a dashed box and indicated by the reference numeral 1122. A first ML model registration process comprises steps 1124 to 1128. A second ML model registration process comprises steps 1130 to 1134.

In the first ML model registration process, the NWDAF MTLF 1104 and/or the ADRF 1110 register the ML Model to the DCCF/MFAF 1106. In the second ML model registration process, the NWDAF MTLF 1104 and/or ADRF 1110 register the ML Model to the NRF 1108. In either way, the ML Model may be distributed towards the corresponding NWDAF AnLF or NWDAF MTLF that request it.

In the first ML model registration process, at step 1124, the NWDAF MTLF 1104 and/or the ADRF 1110 may request to register the ML Model profile (containing any appropriate attribute), including the network state parameter (e.g. network state version and identifier) and optionally including the ML algorithm ID to the DCCF 1106 by invoking a Ndccf_MLModel_Registration.

At step 1126, the DCCF/MFAF 1106 registers the ML model and the corresponding network state parameter (e.g. network state version and/or identifier) including, optionally, the ML algorithm ID.

At step 1128, the DCCF/MFAF 1106 responds to the NWDAF MTLF 1104 and/or the ADRF 1110 with a Ndccf_MLModel_RegistrationResponse.

In the second ML model registration process, at step 1130, the NWDAF MTLF 1104 and/or the ADRF 1110 registers its ML Model profile including the network state parameter (e.g. network state version and/or identifier), and optionally including the ML algorithm ID, to the NRF 1108 by invoking the Nnrf_MLModel_Registration.

At step 1132, the NRF 1108 registers the ML model and the corresponding network state parameter (e.g. network state version and identifier) including, optionally, the ML algorithm ID.

At step 1134, the NRF 1108 responds to the NWDAF MTLF 1104 and/or the ADRF 1110 with a Nnrf_MLModel_RegistrationResponse.

Thus, ML model registration processes are provided.

The ML Model can be provisioned to a consumer, e.g. NWDAF AnLF, (e.g. for inference) or to NWDAF MTLF (e.g. for further training). An ML model provisioning process is depicted in FIG. 11 in a dashed box and indicated by the reference numeral 1136. The ML model provisioning process 1136 comprises steps 1138 to 1144.

At step 1138, the ML Model consumer 1102 optionally issues a search request to the NRF 1108 to find the location of the desired ML Model (e.g. as defined in TS 23.288) by invoking Nnrf_MLModel_SearchRequest. This may include the desired network state parameter (e.g. network state version and identifier) and optionally may include the ML algorithm ID.

At step 1140, the NRF 1108 responds with a Nnrf_MLModel_SearchRequestResponse that contains the ML Model and network state parameter (e.g. network state version and identifier) and may optionally include the ML algorithm ID, if the ML model is available. Otherwise (i.e. if the ML model is not available), the NRF 1108 provides an error message that indicates that the desired ML Model does not exist/is unavailable.

At step 1142, the ML model consumer 1102 (e.g., an NWDAF AnLF or NWDAF MTLF) may request or subscribe, to a (set of) trained ML Model(s) associated with a (set of) Analytics ID(s) and a network state parameter (e.g. network state version and/or identifier) including, optionally, the ML algorithm ID, to the DCCF 1106 or the ADRF 1110 by invoking Nadrf_MLModel_Request/Subscribe.

At step 1144, the ADRF 1110 or DCCF 1106 notifies the ML model consumer 1102 with the trained ML Model Information including the network state parameter and optionally including the ML algorithm ID. This may be done by responding with a Nadrf_MLModel_Request/Subscribe_Response. The response may contain a (set of) file address of the trained ML model.

Thus, an ML model provisioning process 1136 is provided.

In an alternative embodiment, if an analytics service consumer includes a use case context parameter, the NWDAF determines the type of ML model algorithm required to support such use case. The NWDAF may then determine the appropriate ML model algorithm according to the current network state configuration or version. In some embodiments, when the NWDAF determines the network state (e.g. as described in aforementioned text), the NWDAF may interface with the ADRF to obtain an ML model supporting the specific algorithm that was trained based on the determined network state.

In an aspect, there is provided an apparatus comprising a transceiver and a processor coupled to the transceiver. The processor and the transceiver are configured to cause the apparatus to: include, in a message identifying a machine learning model, a network state parameter. The machine learning model is for deriving (e.g., by inference) analytics information for a wireless communication network; the machine learning model has been trained using training data acquired from the wireless communication network when the wireless communication network was in a particular network state. The network state parameter is indicative of that particular network state.

The processor and the transceiver may be further configured to cause the apparatus to send, to another apparatus (e.g., to a network function on another apparatus), the message.

The message may be associated with storage, registration, searching, or provisioning of the machine learning model or of analytics derived therefrom. For example, the message may be a request to store, register, search for, provision, or provide the machine learning model and/or analytics derived therefrom. Also for example, the message may be a storage request response, a registration request response, search results associated with, or a message that provides the machine learning model and/or analytics derived therefrom. Also for example, the message may be a subscription message, such as a subscription request or response (e.g. as described in more detail earlier above) for network analytics information and/or or ML model information.

The message may include an identifier for the machine learning model (e.g., a Model ID). The identifier may comprise an identifier of a machine learning algorithm used to define the machine learning model (e.g. Algorithm ID) combined with (e.g.

concatenated) the network state parameter. Optionally, the message may further comprise an Analytics ID, identifying analytics (e.g. requested analytics).

The network state parameter may be selected from a predefined list of a network state parameters. For example, the processor may be configured to select (or avoid selecting), from the predefined list, the network state parameter.

The network state parameter may specify, comprise, define, or be indicative of one or more of the following: one or more data sources from which the training data was acquired; and/or one or more data statistics information related to the training data.

The network state parameter may specify, comprise, define, or be indicative of one or more of the following: a type of the wireless communication network (e.g. when in the particular network state); one or more network faults, errors, or malfunctions in the wireless communication network (e.g. when in the particular network state); an energy saving state of the wireless communication network (e.g. when in the particular network state); a network maintenance state of the wireless communication network (e.g. when in the particular network state); a network congestion level of the wireless communication network (e.g. when in the particular network state); network configuration (e.g. configuration policies and/or controls) of the wireless communication network (e.g. when in the particular network state); and/or historical data associated with the wireless communication network (e.g. when in the particular network state). The historical data may be as specified in clause 5A.4 and clause 5A.5 of TS 23.288.

The network state parameter may specify, comprise, define, or be indicative of one or more of the following: trace data or an identifier thereof (e.g., a pointer); and/or a trace tool or an identifier thereof (e.g., a pointer). The trace tool may be for use in retrieving a network state or network context. The trace tool may be as defined in, for example, TS 32.421 or TS 32.422, e.g. MDT Server (TCE).

The apparatus may be an apparatus selected from the group of apparatuses consisting of: a Network Data Analytics Function, NWDAF; an NWDAF Model Training Logical Function, MTLF; an NWDAF Analytics Logical Function, AnLF; a Data Collection Coordination Functionality, DCCF; a Messaging Framework Adaptor Function, MFAF; a Network Repository Function, NRF; an Analytical Data Repository Function, ADRF; and a machine learning model consumer.

The processor and the transceiver may be further configured to cause the apparatus to interact with another apparatus (e.g. a network function on another apparatus in the wireless communication network). The processor and the transceiver may be further configured to cause the apparatus to determine the network state parameter based on the interaction, and the information provided. The another apparatus with which the interaction occurs may be an apparatus selected from the group of apparatuses consisting of: an Operations, Administration and Maintenance, OAM, entity; a 5G network function, NF; and a Policy Control Function, PCF.

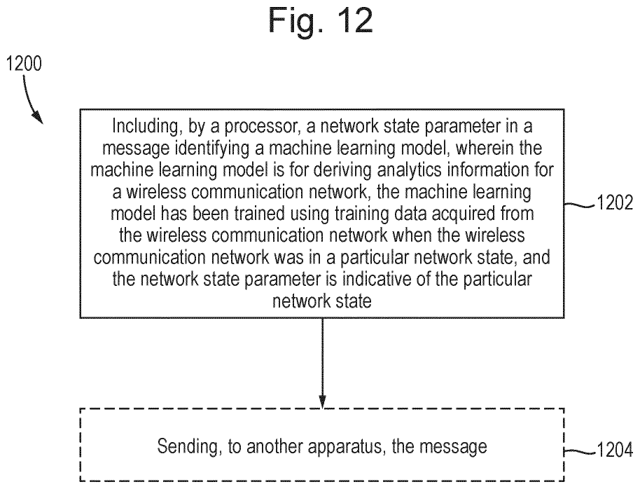

There is further provided a method performable by an apparatus in a wireless communication network. FIG. 12 is a process flow chart showing certain steps of this method 1200. The method 1200 comprises including 1202, by a processor, a network state parameter in a message identifying a machine learning model. The machine learning model is for deriving (e.g., by inference) analytics information for a wireless communication network. The machine learning model has been trained using training data acquired from the wireless communication network when the wireless communication network was in a particular network state. The network state parameter is indicative of the particular network state. The method may, optionally, further include sending 1204, by a transceiver, the message e.g. for use by another apparatus.

There is further provided an apparatus comprising a memory and a processor coupled to the memory. The processor and the memory are configured to cause the apparatus to: store, in the memory, a machine learning model, the machine learning model being for deriving (e.g., by inference) analytics information for a wireless communication network, the machine learning model having been trained using training data acquired from the wireless communication network when the wireless communication network was in a particular network state; and store, in the memory, a network state parameter associated with the machine learning model, the network state parameter being indicative of the particular network state.

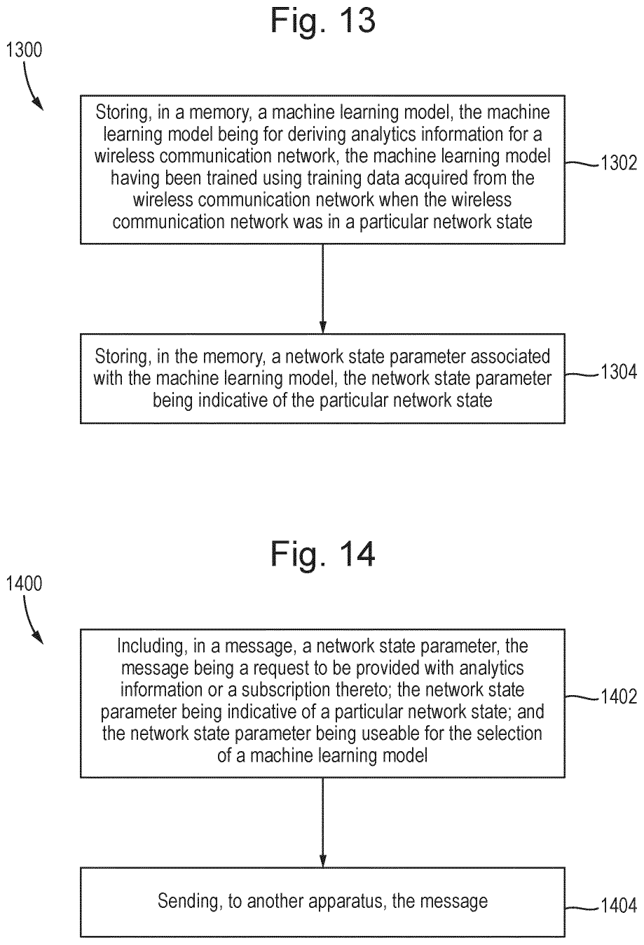

There is further provided a computer-implemented method performable by an apparatus in a wireless communication network. FIG. 13 is a process flow chart showing certain steps of this method 1300. The method 13 comprises: storing 1302, in the memory, a machine learning model, the machine learning model being for deriving analytics information for a wireless communication network, the machine learning model having been trained using training data acquired from the wireless communication network when the wireless communication network was in a particular network state; and storing 1304, in the memory, a network state parameter associated with the machine learning model, the network state parameter being indicative of the particular network state.

There is further provided an analytics consumer comprising a transceiver and a processor coupled to the transceiver. The processor and the transceiver configured to cause the apparatus to include, in a message, a network state parameter. The message is a request to be provided with analytics information or a subscription thereto (i.e. a subscription to receive or be notified about analytics information). The network state parameter is indicative of a particular network state. The network state parameter is useable for the selection of a machine learning model, for example at a NWDAF AnLF. The network state parameter can also be useable for avoiding the selection of a data source for re-training a machine learning model, for example at a NWDAF MTLF, when a NWDAF MTLF receives a re-training request from NWDAF AnLF for a specific different network state. The processor and the transceiver may be further configured to cause the apparatus to send, to another apparatus (e.g., to the NWDAF AnLF), the message.

There is further provided a method for performance by an analytics consumer.

FIG. 14 is a process flow chart showing certain steps of this method 1400. The method 1400 comprises: including 1402, in a message, a network state parameter, wherein: the message is a request to be provided with analytics information or a subscription thereto; the network state parameter is indicative of a particular network state, and is useable for the selection of a machine learning model ML model (e.g. at or by an NWDAF AnLF); and sending 1404 the message to another apparatus, such as an NWDAF AnLF on another apparatus.

In certain embodiments, the methods 1200, 1300, and 1400 may be performed by a processor executing program code, for example, a microcontroller, a microprocessor, a CPU, a GPU, an auxiliary processing unit, a FPGA, or the like.

Conventional methodologies tend to focus on a capability to store and retrieve ML models considering filtering information related to implementation, interoperability, and usage, including requesting and subscribing. Conventional methodologies do not consider the conditions and the network state when training an ML model. An ML model may be trained under a different network state, e.g., due to a base station fault, or energy saving or special event, e.g., a sports game. Different network states, e.g., different network topologies with different mobility and load distributions, may produce distinct trained ML models. These network conditions are not currently visible to ML Model consumers.

The above-described apparatuses and methods introduce a network state parameter/identifier that describes the training conditions of an ML model, e.g., out of a pre-configured list. Such a network state parameter specifies, defines, or reflects network faults, errors, malfunctions, energy saving states, congestion conditions, maintenance, network configuration, active data sources and/or data characteristics.

The above-described apparatuses and methods tend to provide the capability to request information, subscribe, store, search, and retrieve an ML model when a consumer requests a ML model for the purpose of inference or further training under a specific network state.

Conventionally, the network conditions under which a NWDAF MTLF trained an ML model are not described or indicated. Even if the Analytics ID that points to specific data sources that can be used in the training process as well as to the respective geographical area and time is indicated, nevertheless, the network conditions may change (e.g. due to fault, energy saving or special event) altering the network topology, mobility, and traffic distribution, which tends to significantly influence the outcome of ML model training. If these network conditions are not considered in the ML model storage, then its use can prove to be problematic (e.g., a ML model trained under different conditions and/or using different data source and/or using different data source statistics may be selected. This may cause a significant performance drift depending on the usage).

Embodiments described herein address this issue.

Embodiments described herein include a network state parameter in requesting and subscribing analytics and ML model info from the respective NWDAF.

Embodiments described herein include the network state parameter when the NWDAF MTLF stores and/or retrieves an ML model from the ADRF.

Embodiments described herein provide for registration, search, and provision of an ML model including the associated network state in the DCCF/MFAF and/or NRF.

There is provided an apparatus and a method that introduces a network state version or identifier to describe the training conditions or network environment related to a trained ML model for the purpose of storing, registering, searching, and provisioning towards an ML model consumer. The network state version and identifier may be combined with the algorithm ID to describe the Model ID. The network state or network context may include the data sources and data statistics. The network state or network context may additionally include, but is not limited to including, the type of network, network faults, energy saving states, network maintenance, network congestion level, and/or network configuration policies and controls. Pointers to trace tools that can assist the ML model consumer to retrieve the network state or network context may be included. The network state may be obtained in the ML model training entity by interacting with 5G core network or the OAM, or can be obtained by the model training entity.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document:
3GPP 3rd Generation Partnership Project
5G 5th Generation of Mobile Communication
AI/ML Artificial Intelligence/Machine Learning
ADRF Analytical Data Repository Function
AF Application Function
AnLF Analytics Logical Function
API Application Protocol Interface
DCCF Data Collection Coordination Functionality
DNN Data Network Name
eMBB enhanced Mobile Broadband
KPI Key Performance Indicator
MDT Minimization of Driving Test
MF Management Function
MFAF Messaging Framework Adaptor Function
mIoT massive Internet of Things
MnS Management Service
MTLF Model Training Logical Function
NF Network Function
NRF Network Repository Function
NWDAF Network Data Analytics Function
OAM Operations, Administration and Maintenance
PM Performance Measurement
UDM User Data manager
UDR User Data Repository
UE User Equipment
URLLC Ultra Reliable Low Latency Communications
V2X Vehicular to Everything

1. An apparatus comprising:
a memory; and
a processor coupled with the memory and configured to cause the apparatus to:
receive a request message for an analytics service that uses a machine learning (ML) model, the request comprising a use case parameter;
determine the ML model based on the use case parameter and a current network state, wherein the ML model is for deriving analytics information for a wireless communication network; and
transmit a response message comprising analytics service information based on the determined ML model.

2. The apparatus of claim 1, wherein the request message comprises a network use case parameter is indicative of a particular network state, and wherein the processor is configured to cause the apparatus to determine the current network state based on the use case parameter.

3. The apparatus of claim 1, wherein the use case parameter indicates one or more of:
a type of the wireless communication network;
one or more network faults in the wireless communication network;
an energy saving state of the wireless communication network;
a network maintenance state of the wireless communication network;
a network congestion level of the wireless communication network; or
network configuration of the wireless communication network.

4. The apparatus of claim 1, wherein the response message comprises an identifier for the determined ML.

5. The apparatus of claim 4, wherein the identifier for the ML model indicates that the ML model supports a use case identified by the use case parameter.

6. The apparatus of claim 1, wherein the use case parameter is selected from a predefined list of use case parameters.

7. The apparatus of claim 1, wherein to determine the ML model, the processor is configured to cause the apparatus to interact with a network node, and to determine the ML model based on the interaction.

8. The apparatus of claim 7, wherein the network node comprises an Analytical Data Repository Function (ADRF).

9. (canceled)

10. The apparatus of claim 1, wherein the apparatus comprises:
a Network Data Analytics Function (NWDAF);
an NWDAF Model Training Logical Function (MTLF);
an NWDAF Analytics Logical Function (AnLF);
a Data Collection Coordination Functionality (DCCF);
a Messaging Framework Adaptor Function (MFAF);
a Network Repository Function (NRF);
an Analytical Data Repository Function (ADRF); or
ML model consumer.

11. The apparatus of claim 1, wherein to determine the current network state, the processor is configured to cause the apparatus to interact with a network node, and to determine the current network state based on the interaction.

12. The apparatus of claim 11, wherein the network node is an apparatus selected from the group of apparatuses consisting of:
an Operations, Administration and Maintenance (OAM) entity;
a Fifth Generation (5G) network function (NF); or
a Policy Control Function (PCF).

13. A method comprising:
receiving a request message for an analytics service that uses a machine learning (ML) model, the request comprising a use case parameter;
determining the ML model based on the use case parameter and a current network state, wherein the ML model is for deriving analytics information for a wireless communication network; and
transmitting a response message comprising analytics service information based on the determined ML model.

14. (canceled)

15. (canceled)

16. (canceled)

17. (canceled)

18. The method of claim 13, wherein the use case parameter is indicative of a particular network state, and wherein the processor is configured to cause the apparatus to determine the current network state based on the use case parameter.

19. The method of claim 18, wherein the use case parameter indicates one or more of:
a type of the wireless communication network;
one or more network faults in the wireless communication network;
an energy saving state of the wireless communication network;
a network maintenance state of the wireless communication network;
a network congestion level of the wireless communication network; or network configuration of the wireless communication network.

20. The method of claim 13, wherein the response message comprises an identifier for the determined ML model.

21. The method of claim 20, wherein the identifier for the ML model indicates that the ML model supports a use case identified by the use case parameter.

22. The method of claim 13, wherein the use case parameter is selected from a predefined list of use case parameters.

23. The method of claim 13, wherein to determine the ML model, the processor is configured to cause the apparatus to interact with a network node, and to determine the ML model based on the interaction.

24. The method of claim 23, wherein the network node comprises an Analytical Data Repository Function (ADRF).

25. The method of claim 13, wherein the apparatus comprises:
a Network Data Analytics Function (NWDAF);
an NWDAF Model Training Logical Function (MTLF);
an NWDAF Analytics Logical Function (AnLF);
a Data Collection Coordination Functionality (DCCF);
a Messaging Framework Adaptor Function (MFAF);
a Network Repository Function (NRF);
an Analytical Data Repository Function (ADRF); or
a ML model consumer.
